(19) United States
(12) Patent Application Publication
(10) Pub. No.: US 2014/0112334 A1
(43) Pub. Date: Apr. 24, 2014

(54) DEVICE, SYSTEM, AND METHOD OF CONVERSATION PROXY

(71) Applicants: Menachem Shmuel HONIG, Highland Park, NJ (US); Tatiana ADAR, Belle Mead, NJ (US); Ilana SHAPIRO, Staten Island, NY (US); Sharath KUMAR, Somerset, NJ (US)

(72) Inventors: Menachem Shmuel HONIG, Highland Park, NJ (US); Tatiana ADAR, Belle Mead, NJ (US); Ilana SHAPIRO, Staten Island, NY (US); Sharath KUMAR, Somerset, NJ (US)

(21) Appl. No.: 14/049,230

(22) Filed: Oct. 9, 2013

(30) Foreign Application Priority Data
Oct. 23, 2012 (IL) 222647

(51) Int. Cl. H04L 29/06

(52) U.S. Cl. CPC H04L 29/06176
USPC 370/352

(57) ABSTRACT

Device, system, and method of conversation proxy. A method of communication includes: instructing a first network element, which intends to send conversation packets to a second network element via a first route that excludes a Session Border Controller (SBC) server, to send the conversation packets to the second network element via a second route that includes the SBC server.

### CROSS-REFERENCE TO RELATED APPLICATIONS

The present application claims priority and benefit from Israeli patent application number IL 222,647, titled “Device, System, and Method of Conversation Proxy”, filed in the Israeli patent office on Oct. 23, 2012, which is hereby incorporated by reference in its entirety.

### FIELD OF THE INVENTION

The present invention relates to the field of packet-based communication.

### BACKGROUND

A Voice over Internet Protocol (VoIP) network may include various VoIP components, for example, wired Internet Protocol (IP) phones, wireless IP phones, and one or more gateways. Optionally, a Session Border Controller (SBC) may mediate between an internal VoIP network (e.g., operable within an organization or enterprise) and an external VoIP network, or between two other types of networks.

### SUMMARY

The present invention may include, for example, a device, a system, and a method of conversation proxy. For example, the present invention may allow an organizational VoIP network to route some or all VoIP communications to a particular node, at which one or more operations (e.g., content recording or content analysis) may be performed. The present invention may be utilized with other, e.g. non-VoIP or non-voice, types of conversations, for example, video conversations and Instant Messaging (IM) conversations.

In accordance with the present invention, for example, a method of communication may include: instructing a first network element, which intends to send conversation packets to a second network element via a first route that excludes a Session Border Controller (SBC) server, to send the conversation packets to the second network element via a second route that includes the SBC server.

In accordance with the present invention, the method may further include: collecting the conversation packets at the SBC server.

In accordance with the present invention, the method may further include: recording conversations by storing conversation packets centrally collected at the SBC server.

In accordance with the present invention, the method may further include: performing on the conversation packets at least one operation selected from the group consisting of: voice analytics of conversation packets centrally collected at the SBC server, transcription generation of conversation packets centrally collected at the SBC server, speech-to-text conversion of conversation packets centrally collected at the SBC server, face recognition of conversation packets centrally collected at the SBC server, motion detection of conversation packets centrally collected at the SBC server, intruder detection of conversation packets centrally collected at the SBC server, video processing of conversation packets centrally collected at the SBC server.

In accordance with the present invention, the instructing may include: modifying one or more signaling messages exchanged between the first network element and the second network element.

In accordance with the present invention, the modifying may include: modifying one or more Session Description Protocol (SDP) entries of at least one Session Initiation Protocol (SIP) message exchanged between the first network element and the second network element.

In accordance with the present invention, the modifying may include: deleting all local candidates in a Session Description Protocol (SDP) record of a Session Initiation Protocol (SIP) message exchanged between the first network element and the second network element.

In accordance with the present invention, the modifying may include: maintaining only relay candidates in said Session Description Protocol (SDP) record of said Session Initiation Protocol (SIP) message exchanged between the first network element and the second network element.

In accordance with the present invention, a Private Branch Exchange (PBX) server may include: a rule enforcement module to instruct a first network element, which intends to send conversation packets to a second network element via a first route that excludes a Session Border Controller (SBC) server, to send the conversation packets to the second network element via a second route that includes the SBC server.

In accordance with the present invention, the rule enforcement module is to modify one or more signaling messages exchanged between the first network element and the second network element.

In accordance with the present invention, the rule enforcement module is to modify one or more Session Description Protocol (SDP) entries of at least one Session Initiation Protocol (SIP) message exchanged between the first network element and the second network element.

In accordance with the present invention, the rule enforcement module is to delete all local candidates in a Session Description Protocol (SDP) record of a Session Initiation Protocol (SIP) message exchanged between the first network element and the second network element.

In accordance with the present invention, the rule enforcement module is to maintain only relay candidates in said Session Description Protocol (SDP) record of said Session Initiation Protocol (SIP) message exchanged between the first network element and the second network element.

In accordance with the present invention, a communication system may include the PBX server, and may further include: a Session Border Controller (SBC) server comprising a content collector to centrally collect in real time said conversation packets.

In accordance with the present invention, the communication system may further include: a media recorder to record in real time a conversation represented by said centrally-collected conversation packets.

In accordance with the present invention, the communication system may further include: a media analyzer to perform content analysis in real time on content represented by said centrally-collected conversation packets.

In accordance with the present invention, the media analyzer is to perform on said centrally-collected conversation packets at least one operation selected from the group consisting of: voice analytics of said centrally-collected conversation packets, transcription generation of said centrally-collected conversation packets, speech-to-text conversion of said centrally-collected conversation packets, face recognition of said centrally-collected conversation packets, motion detection of said centrally-collected conversation packets, intruder detection of said centrally-collected conversation packets, video processing of said centrally-collected conversation packets.

The present invention may provide other and/or additional benefits or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a communication system in accordance with the present invention; and

FIG. 2 is a signaling diagram demonstrating a method of routing conversations in accordance with the present invention.

### DETAILED DESCRIPTION OF THE PRESENT INVENTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Applicants have realized that an organizational VoIP network may not be properly structured in order to allow both efficient routing of VoIP packets as well as recording of voice conversations. Applicants have realized that it may be efficient and/or beneficial to route some or all VoIP packets to a particular node in a VoIP network, and to record voice communications at that node. Applicants have also realized that the central routing of all network traffic to a particular node in the organizational network, may allow performing other suitable operations on such centrally-collected media content.

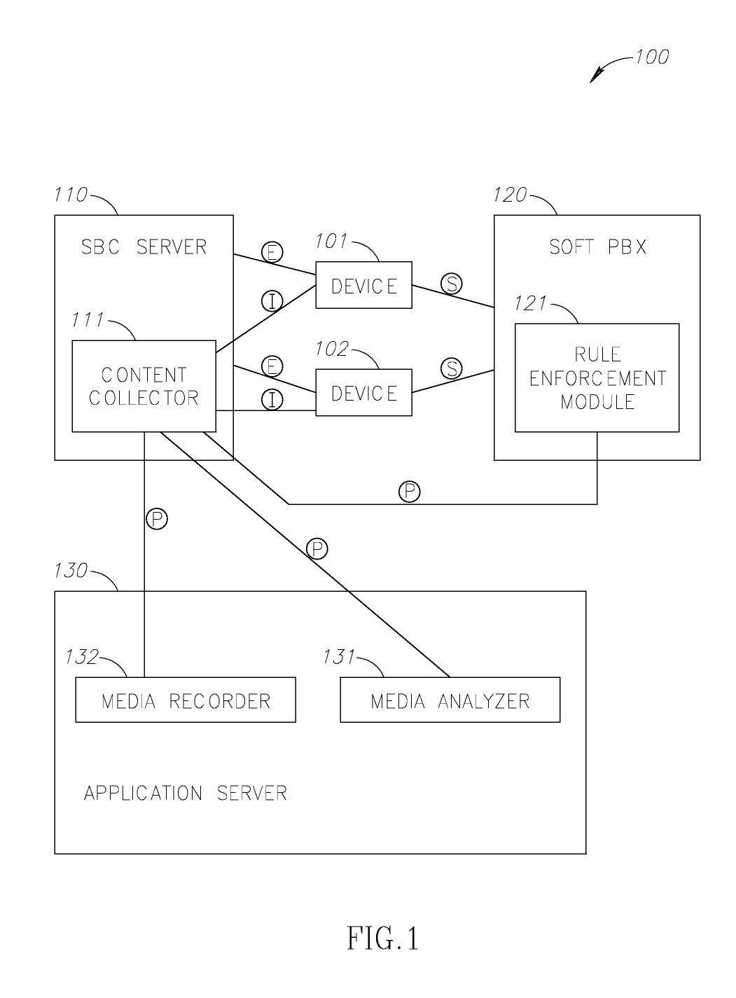

Reference is made to FIG. 1, which is a schematic block diagram illustration of a communication system 100 in accordance with the present invention. System 100 may include, for example, a Session Border Controller (SBC) server 110, a soft Private Branch Exchange (PBX) server 120, an application server 130, and one or more end-user devices, for example, devices 101 and 102. Components of system 100 may be implemented using a suitable combination of hardware units and/or software modules, and may be able to communicate among themselves using one or more wired links and/or wireless links.

SBC server 110 may be an “edge” server, located at an edge of an organizational communication network. SBC server 110 may allow devices 101-102 to communicate and collaborate with devices external to system 100, or external to a firewall or other security components of an organizational network. SBC server 110 may include a content collector 111, which may be a hardware component and/or a software module able to collect content or media (e.g., voice, video, Instant Messaging (IM), or other data) of conversation(s) that are relayed through SBC server 110. Optionally, SBC server 110 may be implemented by utilizing a scalable Microsoft Lync server, configured for load balancing and high availability, supporting multiple concurrent conversations. SBC server 110 may be implemented as a configuration or modification of an already-existing SBC or network server, thereby reducing the need to introduce to the network and later maintain a new server or a new node, and thereby avoiding addition of a possible point-of-failure along user conversation paths. SBC server 110 may support one or more Network Address Translation (NAT) traversing standards or other routing techniques for establishing and/or maintaining IP connections, example, Session Traversal Utilities for NAT (STUN), Traversal Using Relay NAT (TURN), or Interactive Connectivity Establishment (ICE).

Soft PBX server 120 may be a “front end” server or a virtual PBX server, and may be responsible for one or more communication functions, for example, user authentication, user registration, and conversation routing, and more. Soft PBX server 120 may include a rule enforcement module 121, which may be a hardware component and/or a software module able to apply or enforce routing rules for conversations media. In a demonstrative embodiment of the present invention, rule enforcement module 121 may modify received Lync messages in order to force Lync end-user devices to relay conversations through SBC server 110 (the “edge” server).

Optionally, SBC server 110 and/or soft PBX server 120 may be implemented by utilizing a Microsoft Lync Unified Communication Solution module, which may utilize and/or extend a Session Initiating Protocol (SIP) for providing voice communication, video communication, Instant Messaging (IM) functions, file transfers, and/or desktop sharing functions. Other suitable unified communication solutions may be used.

Application server 130 may be a computer, a hardware unit and/or a software module able to run one or more applications with regard to network traffic and media content which passes through SBC server 110. For example, application server 130 may include a media recorder module 132 able to record (e.g., store for long term) such pass-through media content, and a media analyzer 131 able to perform content-analysis operations on collected media content.

Each one of devices 101-102 may include, for example, a telephone unit, a telephone end-user device, an Internet Protocol (IP) aware phone or an IP-phone, a smartphone or tablet able to interface with an organizational telephony system, a corded or cordless phone of an organizational telephony system, or the like. Optionally, devices 101-102 may be configured to support or include Microsoft Lync or other suitable type of media handling solution.

In FIG. 1, links denoted with “S” may indicate signaling or control signals, rather than media content; links denoted with “I” may indicate network-internal media transfers, whereas links denoted with “E” may indicate external media transfers; and links denoted with “P” may indicate proprietary signaling in accordance with the present invention.

In accordance with the present invention, modifications or rules may be applied to signaling messages in system 100, in order to force routing of conversations through SBC server 110, even though such conversations need not necessarily be routed through SBC server 110 in order to reach their destination. As such conversations pass through SBC server 110, application server 130 may record the passing conversations, and/or may perform other suitable operations with regard thereto. For example, application server 130 may include one or more modules which may utilize a central location at which conversation data is collected, for example, various conversation recording or analysis modules, voice analytics modules, transcription modules (e.g., able to convert voice-to-text or speech-to-text), security applications (e.g., face recognition, motion detection, video processing, intruder detection), or the like.

System 100 may be structured such that content or media originating from device 101 or destined to device 102 may be routed through one or more network routes or network paths. Prior to establishment of a conversation, device 101 may discovers network addresses on which device 101 may receive contents or media of conversations. The paths or routes may include, for example, routes based on host network interfaces of a user, routes based on one or more global IP addresses of the user (e.g., utilizing STUN), and/or routes based on media relay addresses of SBC server 110 (e.g., utilizing TURN). Prior to conversation establishment, device 101 may reserve network media relay addresses on SBC server 110 for a subsequent conversation. Signaling messages (e.g., Lync messages, Session Initiation Protocol (SIP) messages, Lync/SIP messages, or other suitable types of signaling messages) may be intercepted and/or modified at soft PBX server 120, such that some or all conversations may be relayed through SBC server 110.

The present invention may operate in conjunction with a variety of call scenarios, for example: (a) a call between two devices that are internal to the organizational network, for example, IP phones and/or IP soft clients that are registered with soft PBX server 120; (b) a call between a device internal to the organizational network, and an external device such as a home phone or a cellular phone utilizing PSTN; (c) a conference call or a three-way call between three or more telephony devices of any suitable combination (e.g., internal to the organization, external to the organization, PSTN devices, IP telephony devices); (d) a call between two devices that are external to the organizational network, for example, IP phones and/or IP soft clients, or mobile clients that are registered with soft PBX server 120 but are external to the organizational network; (e) a call between a device external to the organizational network, and a home-based PSTN device or a cellular device accessible over the PSTN; (f) a conference call among three or more devices that are external to the organizational network; (g) a call between any device which is internal to the organization network, and any device that is external to the organizational network.

In accordance with the present invention, instead of a conventional media flow among devices, rule enforcement module 121 may ensure that media flows through SBC server 110, which in turn may be equipped with media collector 111, thereby allowing the operably-connected application server 130 to record or otherwise analyze the media. In accordance with the present invention, for example, all signaling messages may be proxied through rule enforcement module 121, which may examine or analyze or inspect signaling messages before they are sent to a destination, may check some or all possible routes, and may force the route (e.g., by modifying, editing, filtering, diluting, removing, adding and/or deleting signaling messages, or portions or lines of signaling messages) through SBC server 110, for example, by removing all other routes or paths.

Reference is now made to Code 1, which demonstrates entries of Session Description Protocol (SDP) in SIP messages prior to intervention or modification by rule enforcement module 121:

Code 1

| | |
|---|---|
| Line 1 | a_candidate:1 1 UDP 2130706431 |
| | 172.21.205.155 25404 typ host |
| Line 2 | a_candidate:1 2 UDP 2130705918 |
| | 172.21.205.155 25405 typ host |
| Line 3 | a_candidate:2 1 tcp-pass 6555135 192.168.0.1 54356 |
| | typ relay raddr 172.21.205.155 rport 20252 |
| Line 4 | a_candidate:2 2 tcp-pass 6555134 192.168.0.1 54356 |
| | typ relay raddr 172.21.205.155 rport 20252 |
| Line 5 | a_candidate:3 1 UDP 16647679 192.168.0.1 50732 |
| | typ relay raddr 172.21.205.155 rport 4846 |
| Line 6 | a_candidate:3 2 UDP 16647678 192.168.0.1 53561 |
| | typ relay raddr 172.21.205.155 rport 4847 |
| Line 7 | a_candidate:4 1 tcp-act 7076863 192.168.0.1 54356 |
| | typ relay raddr 172.21.205.155 rport 20252 |
| Line 8 | a_candidate:4 2 tcp-act 7076350 192.168.0.1 54356 |
| | typ relay raddr 172.21.205.155 rport 20252 |
| Line 9 | a_candidate:5 1 tcp-act 1684797951 172.21.205.155 20252 |
| | typ srflx raddr 172.21.205.155 rport 20252 |
| Line 10 | a_candidate:5 2 tcp-act 1684797438 172.21.205.155 20252 |
| | typ srflx raddr 172.21.205.155 rport 20252 |

Reference is made to Code 2, which demonstrates entries of SDP in SIP messages as modified by rule enforcement module 121, in accordance with the present invention:

Code 2

| | |
|---|---|
| Line 5 | a_candidate:3 1 UDP 16647679 192.168.0.1 50732 |
| | typ relay raddr 172.21.205.155 rport 4846 |
| Line 6 | a_candidate:3 2 UDP 16647678 192.168.0.1 53561 |
| | typ relay raddr 172.21.205.155 rport 4847 |

As demonstrated, rule enforcement module 121 deleted or removed from Code 1 several lines (lines 1-4 and lines 7-10), and kept only lines 5-6, in order to produce Code 2. For example, only relay candidates (and not direct communication candidates) were maintained and kept in the SIP SDP; and therefore, the receiving device may attempt to reach the sender device only through relay IP and ports, i.e., through the address of SBC server 110.

It is noted that the components of system 100 may be implemented by utilizing various additional sub-units, hardware components and/or software modules. In a demonstrative implementation, rule enforcement module 121 may be implemented by utilizing multiple modules or sub-units, for example, a signaling messages modifier, a signaling messages filter, a signaling messages editor, a signaling messages entry remover, an instructor module (e.g., able to instruct other network elements how to route packets or operate), an DSP record editor or modifier or remover, or the like. In another demonstrative implementation, media analyzer 131 may include, for example, a voice analytics module, a transcription generator, a speech-to-text converter, a face recognition module, a motion detector, an intruder detector, a video processing module, or the like. Other suitable components and/or modules may be used.

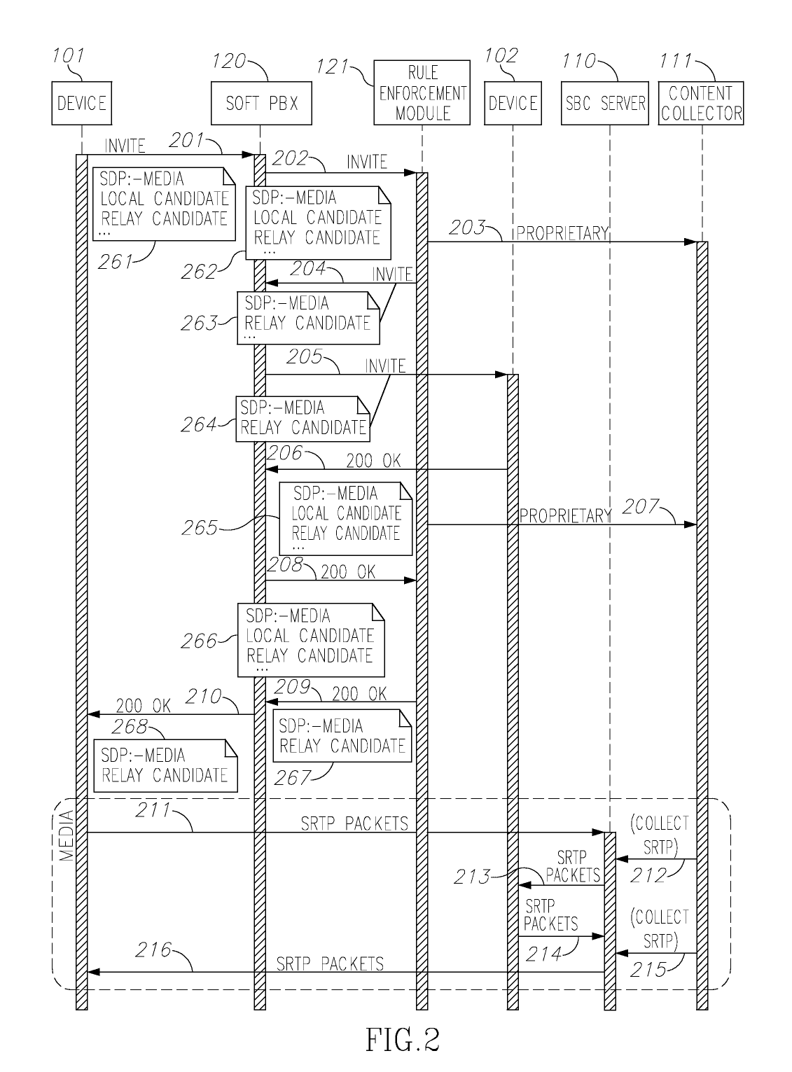

Reference is made to FIG. 2, which is a signaling diagram demonstrating a method of routing conversations in accordance with the present invention. The method may be used, for example, by system 100 of FIG. 1, or by other suitable systems, devices and/or components.

As demonstrated in FIG. 2, signaling messages may be modified or edited, or their SIP SDP may be modified or diluted; and particularly, in Invite messages, local candidates may be removed or deleted or excluded, whereas only relay candidates may be kept or maintained. For example, rule enforcement module 121 may receive the whole SDP which may include eboth local candidate(s) and relay candidate(s); may remove all the local candidates, and may keep only relay candidate(s); and may then sends the SIP message with the modified SDP (e.g., signaling messages such as Invite, 183 Progress, 200OK) back to soft PBX 120. When the receiving device receives such SDP, it sees only one possible route for sending the media back to the sender, which is, through the relay candidate, SBC server 110. The original and the modified SIP SDP items are denoted 261-268 in the demonstrative example of FIG. 2. It is noted that the term “200 OK” is used herein for demonstrative purposes, and may include, for example, other suitable types of response, acknowledgement response, a confirmation response, a similar response with SIP SDP, or the like.

In order to establish a conversation between device 101 and device 102, as demonstrated in FIG. 2, device 101 may send a SIP Invite signal to soft PBX 120 (arrow 201), which in turn may send a SIP Invite signal to rule enforcement module 121 (arrow 202). Rule enforcement module 121 may send a first proprietary signal to content collector 111 (arrow 203); for example, rule enforcement module 121 may provide to content collector 111 the media IPs and Ports, as well as call info that the media is to be correlated with. Rule enforcement module 121 may send proprietary message(s) to discover where to “fork” or re-route the media, and may receive reply with IPs and Ports indicating where the media is to be “forked” or re-routed. Rule enforcement 121 may then send a SIP Invite response to soft PBX 120 (arrow 204). It is noted that rule enforcement module 121 may not transfer, relay, send or receive the actual media stream or media packets; rather, rule enforcement module 121 may modify or manipulate signaling messages, and may send call information and/or media description to content collector 111.

Soft PBX 120 may then send a SIP Invite signal to device 102 (arrow 205), which may respond with a “200 OK” signal (arrow 206). Then, rule enforcement module 121 may send a second proprietary signal to content collector 111 (arrow 207).

Soft PBX 120 may send a “200 OK” signal to rule enforcement module 121 (arrow 208); which may then respond with a “200 OK” signal having only a relay candidate after removing the local candidate(s). Soft PBX 120 may send a “200 OK” signal to device 101 (arrow 210), thereby establishing a connection between device 101 and device 102 which depends on the relay candidate(s) and does not include local candidate(s).

As indicated by a rectangle 250, media packets (e.g., SRTP packets) may be exchanged between device 101 and device 102, indirectly through SBC server 110 which may allow data collection by content collector 111. For example, device 101 may send to SBC server 110 a first stream (or stream-portion) of Secure Real-Time Protocol (SRTP) packets that are intended for device 102 (arrow 211). Content collector 111 may seamlessly collect from SBC server 110 the first stream (or stream-portion) of SRTP packets (arrow 212); and SBC server 110 may send the first stream (or stream-portion) of SRTP packets to their destination, device 102 (arrow 213). Similarly, device 102 may send to SBC server 110 a second stream (or stream-portion) of SRTP packets that are intended for device 101 (arrow 214). Content collector 111 may seamlessly collect from SBC server 110 the second stream (or stream-portion) of SRTP packets (arrow 215); and SBC server 110 may send the second stream (or stream-portion) of SRTP packets to their destination, device 101 (arrow 216). It is noted that the first stream and the second stream of SRTP packets may be sent concurrently and in real time, or in overlapping or partially-overlapping time frames; and the SRTP stream may be seamlessly collected by content collector 111 in real time.

Other suitable signaling may be used, and other suitable order of signaling may be used, in accordance with the present invention.

The present invention may provide one or more benefits or advantages, for example: reduced hardware cost, by avoiding a need to introduce an additional server into an existing organizational network; reduced development cost, by avoiding a need to develop and maintain additional software component on the network; and/or increased reliability and quality of service, as the present invention may utilize and leverage already-existing infrastructure and an already-compatible and interoperable SBC server 110.

Applicants have realized that various organizations may need, or may be required to, efficiently collect and/or record voice communications, video communications, Instant Messaging (IM) communications, and/or other types of conversations or communications, due to regulatory requirements, due to third party requirements (e.g., insurer or auditor), for business purposes (e.g., for quality assurance), for training purposes, for employee evaluation purposes, for security purposes (e.g., to uncover information leakage of business espionage), or for other purposes.

The present invention may eliminate or alleviate technological challenges that some users may have when designing, developing and/or deploying a Microsoft Lync solution for organizational communication, and particularly, a difficulty or inability to access and/or intercept the contents or media of conversations while implementing conventional solutions which attempt to collect or record metadata and/or content of conversations.

Applicants have realized that a conventional solution in which traffic is mirrored for purposes of conversation recording, may suffer from multiple deficiencies. For example, a conventional solution may mirror network traffic from the network routers that are in the conversations route; the mirroring may leave the conversations unchanged, neither intervened nor rerouted. Applicants have realized that such mirroring may suffer from multiple deficiencies, for example: a need to modify or configure customer network components (e.g., routers) in order to deploy the mirroring solution; a need to modify or re-configure customer network components (e.g., routers), upon other change(s) in the customer network (e.g., upon adding of end-user devices); an increase in network maintenance complexity. Furthermore, in some networks, a mirroring solution may be virtually impossible to implement due to particular network topology, for example, if end-user devices are distributed over a large campus or are scattered through one or more wide locations. Additionally, mirroring may sometimes be impossible or inefficient due to the need to aggregate traffic that sums up to a bandwidth that exceeds the available bandwidth of the mirroring port.

Applicants have further realized that merely utilizing a “collecting application”, which may be a proprietary application that is installed and runs on each and every end-user device and collects that end-user device conversations, may suffer from multiple deficiencies, for example: it may be inapplicable for some types of end-user devices (e.g., “hard” phones); the solution utilizes architecture which is distributed over multiple user machines; troubleshooting and maintenance of such solution may be complicated; and the solution relies on cooperation and/or skills of a human end-user.

Applicants have also realized that a conventional solution, in which a proxy server is added to a network, and conversations are routed through such proxy server, also suffers from multiple deficiencies. For example, such architecture may have a potential single point of failure; the proxy server may degrade the quality of conversations, or may cause other conversation quality issues, due to various hardware or software outages; the proxy server may not be compatible or interoperable with other servers on the network; the proxy server may not be able to support (partially or fully) NAT standards, which in turn may cause failure of NAT-requiring user conversations.

Applicants have additionally realized that a “conference-in” solution, which elevates peer to peer conversation to a conference call and adds thereto an automated application user (“bot”) (application user), may suffer from multiple deficiencies. For example, this structure may consume conference resources; may delay conversation establishment; and/or may reduce the quality of conversations. Furthermore, some implementations may require the end-user to manually add (conference-in) the “bot” into the conversation, thereby relying on human cooperation or skills. Additionally, this implementation may suffer from the deficiencies discussed above with regard to a “collecting application” structure.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” or “a plurality” as used herein include, for example, “multiple” or “two or more”. For example, “a plurality of items” includes two or more items.

Some embodiments may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

Some embodiments may be implemented by software, by hardware, or by any combination of software and/or hardware as may be suitable for specific applications or in accordance with specific design requirements. Some embodiments may include units and/or sub-units, which may be separate of each other or combined together, in whole or in part, and may be implemented using specific, multi-purpose or general processors or controllers. Some embodiments may include buffers, registers, stacks, storage units and/or memory units, for temporary or long-term storage of data or in order to facilitate the operation of particular implementations.

Some embodiments may be implemented, for example, using a machine-readable medium or article which may store an instruction or a set of instructions that, if executed by a machine, cause the machine (e.g., a computer or an electronic device) to perform a method and/or operations described herein.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments of the present invention have been illustrated and described herein, many modifications, substitutions, changes, and equivalents may occur to those skilled in the art. Accordingly, the claims are intended to cover all such modifications, substitutions, changes, and equivalents.

What is claimed is:

1. A method of communication, the method comprising:
instructing a first network element, which intends to send conversation packets to a second network element via a first route that excludes a Session Border Controller (SBC) server, to send the conversation packets to the second network element via a second route that includes the SBC server.

2. The method of claim 1, further comprising:
collecting the conversation packets at the SBC server.

3. The method of claim 2, further comprising:
recording conversations by storing conversation packets centrally collected at the SBC server.

4. The method of claim 2, further comprising:
performing on the conversation packets at least one operation selected from the group consisting of:
voice analytics of conversation packets centrally collected at the SBC server,
transcription generation of conversation packets centrally collected at the SBC server,
speech-to-text conversion of conversation packets centrally collected at the SBC server,
face recognition of conversation packets centrally collected at the SBC server,
motion detection of conversation packets centrally collected at the SBC server,
intruder detection of conversation packets centrally collected at the SBC server,
video processing of conversation packets centrally collected at the SBC server.

5. The method of claim 1, wherein instructing comprises:
modifying one or more signaling messages exchanged between the first network element and the second network element.

6. The method of claim 1, wherein modifying comprises:
modifying one or more Session Description Protocol (SDP) entries of at least one Session Initiation Protocol (SIP) message exchanged between the first network element and the second network element.

7. The method of claim 1, wherein modifying comprises:
deleting all local candidates in a Session Description Protocol (SDP) record of a Session Initiation Protocol (SIP) message exchanged between the first network element and the second network element.

8. The method of claim 1, wherein modifying further comprises:
maintaining only relay candidates in said Session Description Protocol (SDP) record of said Session Initiation Protocol (SIP) message exchanged between the first network element and the second network element.

9. A Private Branch Exchange (PBX) server comprising:
a rule enforcement module to instruct a first network element, which intends to send conversation packets to a second network element via a first route that excludes a Session Border Controller (SBC) server, to send the conversation packets to the second network element via a second route that includes the SBC server.

10. The PBX server of claim 9, wherein the rule enforcement module is to modify one or more signaling messages exchanged between the first network element and the second network element.

11. The PBX server of claim 9, wherein the rule enforcement module is to modify one or more Session Description Protocol (SDP) entries of at least one Session Initiation Protocol (SIP) message exchanged between the first network element and the second network element.

12. The PBX server of claim 9, wherein the rule enforcement module is to deleting all local candidates in a Session Description Protocol (SDP) record of a Session Initiation Protocol (SIP) message exchanged between the first network element and the second network element.

13. The PBX server of claim 9, wherein the rule enforcement module is to maintain only relay candidates in said Session Description Protocol (SDP) record of said Session Initiation Protocol (SIP) message exchanged between the first network element and the second network element.

14. A communication system comprising the PBX server of claim 9, and further comprising:
a Session Border Controller (SBC) server comprising a content collector to centrally collect in real time said conversation packets.

15. The communication system of claim 14, further comprising:
a media recorder to record in real time a conversation represented by said centrally-collected conversation packets.

16. The communication system of claim 14, further comprising:
a media analyzer to perform content analysis in real time on content represented by said centrally-collected conversation packets.

17. The communication system of claim 16, wherein the media analyzer is to perform on said centrally-collected conversation packets at least one operation selected from the group consisting of:
voice analytics of said centrally-collected conversation packets,
transcription generation of said centrally-collected conversation packets,
speech-to-text conversion of said centrally-collected conversation packets,
face recognition of said centrally-collected conversation packets,
motion detection of said centrally-collected conversation packets,
intruder detection of said centrally-collected conversation packets,
video processing of said centrally-collected conversation packets.
